(19) United States
(12) Patent Application Publication
(10) Pub. No.: US 2016/0311698 A1
(43) Pub. Date: Oct. 27, 2016

(54) ULTRAVIOLET-RAY LAMP WATER STERILIZATION DEVICE AND METHOD FOR CONTROLLING THE SAME

(71) Applicant: MAXTEC PLASTICS, INC., TAICHUNG CITY (TW)

(72) Inventor: SHIH PING LEE, TAICHUNG CITY (TW)

(21) Appl. No.: 14/810,770

(22) Filed: Jul. 28, 2015

(30) Foreign Application Priority Data
Apr. 24, 2015 (TW) 104113161

(51) Int. Cl. C02F 1/32

(52) U.S. Cl. CPC C02F 1/325; C02F 2201/326; C02F 2209/40; C02F 2303/04

(57) ABSTRACT

An ultraviolet-ray lamp water sterilization device includes a body with a path formed between first and second connection holes of the body. An exposing portion is located in the body and between the first and second connection holes. A sterilization unit is located in the exposing portion and has an ultraviolet-ray lamp. A water flow pressure switch is connected to the second connection hole and communicating with the path. A circuit controlling member is electrically connected with the sterilization unit and the water flow pressure switch. The circuit controlling member stops the operation of the sterilization unit when water maintains stationary for a pre-set period of time. The circuit controlling member provides warning signals when the ultraviolet-ray lamp reaches pre-set scenarios. The integral and modularized design is beneficial to assembling.

### BACKGROUND OF THE INVENTION

1. Fields of the Invention

The present invention relates to a water sterilization device, and more particularly, to a water sterilization device using at least one ultraviolet-ray lamp to sterilize water, and a method to control the operation of the water sterilization device.

2. Descriptions of Related Art

The conventional tap water in some areas contains sediment, heavy metal, pesticide residue or germs, a proper water treatment device is used to obtain better quality of water. Ultraviolet-ray lamp is usually applied to be one of the effective ways to sterilize the water, the ultraviolet ray can prevent the germs or micro-organisms from reproduction by means of reaction of the wavelength of the ultraviolet ray.

FIGS. 9 and 10 show the conventional water sterilization device 9 using an ultraviolet-ray lamp to sterilize water. The water sterilization device 9 is connected with a water treatment unit 8. The water sterilization device 9 comprises housing 91, an end cover 92 connected to the housing 91, and an ultraviolet-ray lamp 93 is located in the housing 91. The ultraviolet-ray lamp 93 is connected with a cable 94 which is connected with an adaptor 941. The housing 91 has an inlet 911 and an outlet 912, water is introduced into the housing 91 from the inlet 911 and exposed by the ultraviolet-ray emitted from the ultraviolet-ray lamp 93 so as to be treated. The treated water comes out from the outlet 912. The ultraviolet-ray lamp can also be in the spiral form as shown in FIG. 11, and the power supply is connected to one end of the ultraviolet-ray lamp.

When the outlet 912 is not opened to let the water to come out, the water is still and keeps on being exposed to the ultraviolet-ray lamp 93, and this makes the still water have a high temperature so that when this portion of the water is released from the outlet 912, the high temperature may burn some users, and most of the users discard the water with high temperature. This wastes water significantly, and reduces the service lift of the ultraviolet-ray lamp 93.

The inlet 911 and the outlet 912 are welded to the metal housing, and the end cover 92 has to be machined to have threads 921 so as to be connected to the housing 91. These welding and lathing threads processes increase the manufacturing cost. The conventional water sterilization device 9 using the ultraviolet-ray lamp 93 is not remindful for maintenance because it does not have warning device and auto-stop device.

The present invention intends to provide an ultraviolet-ray lamp water sterilization device to eliminate the shortcomings mentioned above.

### SUMMARY OF THE INVENTION

The present invention relates to an ultraviolet-ray lamp water sterilization device and comprises a body having a first room and a second room defined therein. A first connection hole and a second connection hole are respectively formed in the body and communicate with the first room. A path is formed between the first and second connection holes. An exposing portion is located in the first room and between the first and second connection holes. A sterilization unit is located in the exposing portion. A water flow pressure switch is connected to the second connection hole and communicates with the path. A circuit controlling member is located in the second room and has a driving adaptor. The circuit controlling member is electrically connected with the sterilization unit and the water flow pressure switch. The circuit controlling member stops operation of the sterilization unit when water maintains stationary for a pre-set period of time.

Preferably, the water flow pressure switch comprises a piston, a spring and a magnetic switch, wherein the piston is biased by the spring so as to movably seal an inlet which communicates with the path. The magnetic switch has two magnets which are respectively located in the piston and in the wall of the water flow pressure switch.

Preferably, the body is composed of a first half and a second half.

Preferably, the exposing portion has a first connector, a metallic reaction chamber and a second connector, wherein the first and second connectors are respectively connected to two ends or two sides of the metallic reaction chamber. The sterilization unit is located in the metallic reaction chamber.

Preferably, the body has a window view which communicates with an interior of the metallic reaction chamber.

Preferably, the sterilization unit has an ultraviolet-ray lamp which has a bar connected to one end thereof. The body has a side cover removably connected thereto which is located corresponding to the bar.

Preferably, the ultraviolet-ray lamp water sterilization device has a wireless communication module which transmits signal therefrom and receives signals from outside.

The present invention also provides a method for controlling an ultraviolet-ray lamp water sterilization device, and comprises the following steps:

a step of installing an exposing portion: installing an exposing portion in a body and the exposing portion located between a first connection hole and a second connection hole of the body, a path being formed between the first and second connection holes;

a step of installing a sterilization unit: installing a sterilization unit in the exposing portion;

a step of installing a water flow pressure switch: installing a water flow pressure switch to the second connection hole of the body;

a step of installing a circuit controlling member: installing a circuit controlling member in the body, the circuit controlling member having an adaptor and electrically connected with the sterilization unit and the water flow pressure switch, the circuit controlling member stopping operation of the sterilization unit when water maintains stationary for a pre-set of time, and

a step of timing the sterilization unit: the circuit controlling member having a timer which counts operation time of an ultraviolet-ray lamp of the sterilization unit.

Preferably, in the step of installing a circuit controlling member, the sterilization unit is activated for a pre-set period of time and then stops when the water remains still for a pre-set period of time.

Preferably, in the step of installing a circuit controlling member, a warning device is installed which includes a Light Emitting Diode and/or a buzzer so as to respond to pre-set scenarios of the ultraviolet-ray lamp of the sterilization unit.

The objective of the present invention is to provide an integral and modularized ultraviolet-ray lamp water sterilization device which is simplified and intelligent, and also reduces the manufacturing cost.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the ultraviolet-ray lamp water sterilization device of the present invention;

FIG. 2 is an exploded view of the ultraviolet-ray lamp water sterilization device of the present invention;

FIG. 3 is a cross sectional view of the ultraviolet-ray lamp water sterilization device of the present invention;

FIG. 4 is an enlarged and cross sectional view to shown the operation of the water flow pressure switch of the ultraviolet-ray lamp water sterilization device of the present invention;

FIG. 5 shows that the ultraviolet-ray lamp water sterilization device of the present invention is connected with a water treatment device;

FIG. 6 is a cross sectional view of the second embodiment of the ultraviolet-ray lamp water sterilization device of the present invention;

FIG. 7 is an exploded view of the ultraviolet-ray lamp water sterilization device of the present invention in FIG. 6;

FIG. 8 shows the steps of the method for controlling the ultraviolet-ray lamp water sterilization device of the present invention;

FIG. 9 shows the conventional water sterilization device;

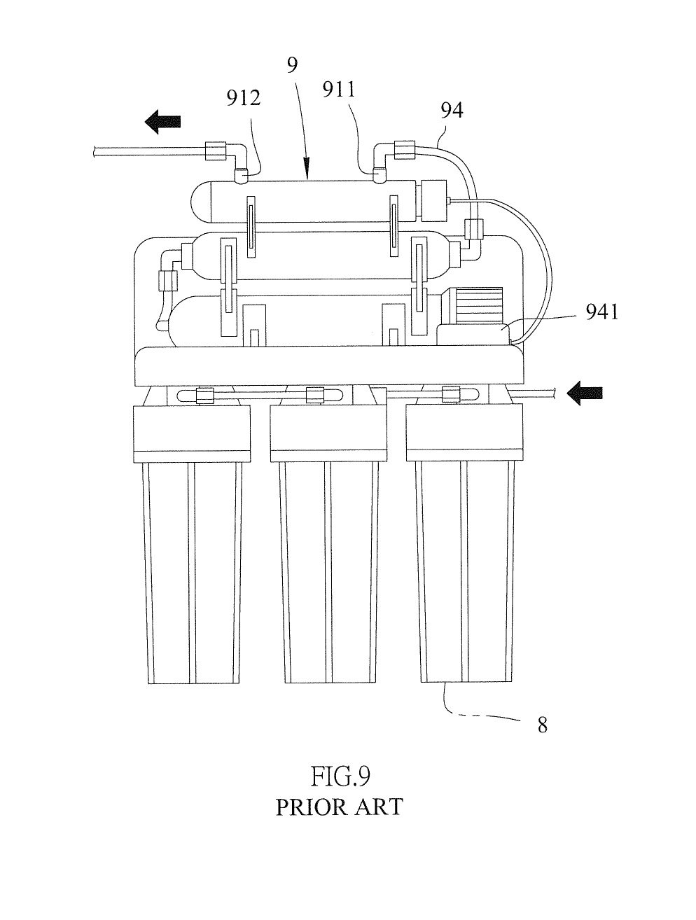

FIG. 10 is a cross sectional view of the conventional water sterilization device disclosed in FIG. 9, and

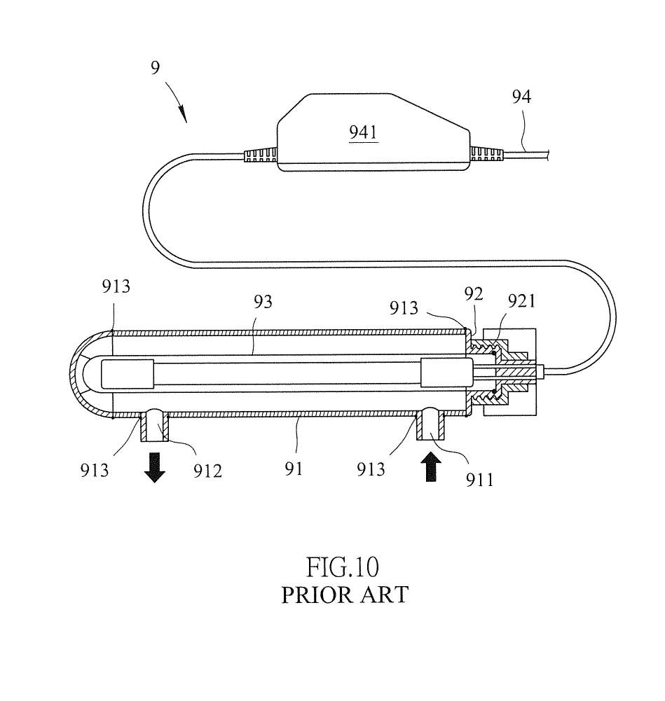

FIG. 11 is a cross sectional view of another conventional water sterilization device.

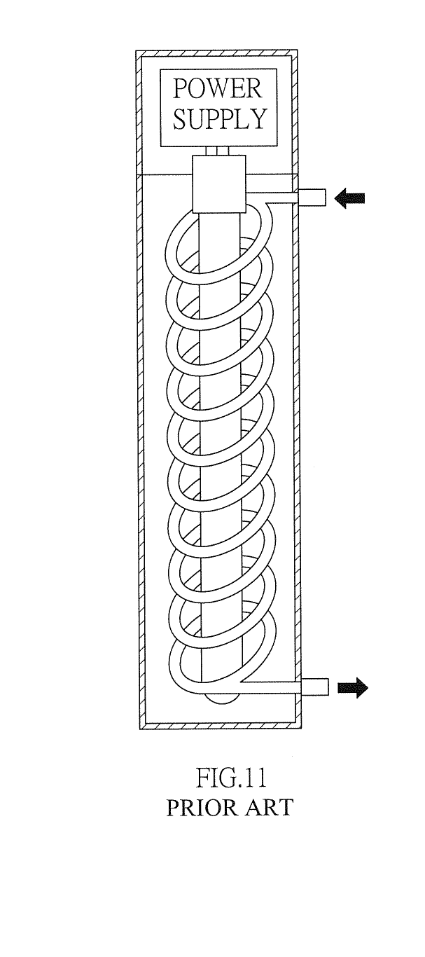

### DETAILED DESCRIPTION OF THE PREFERRED EMBODIMENT

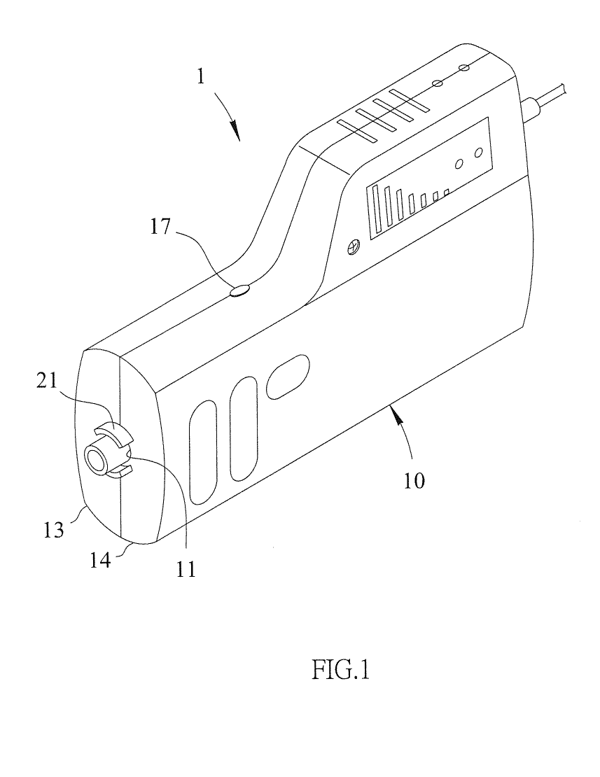

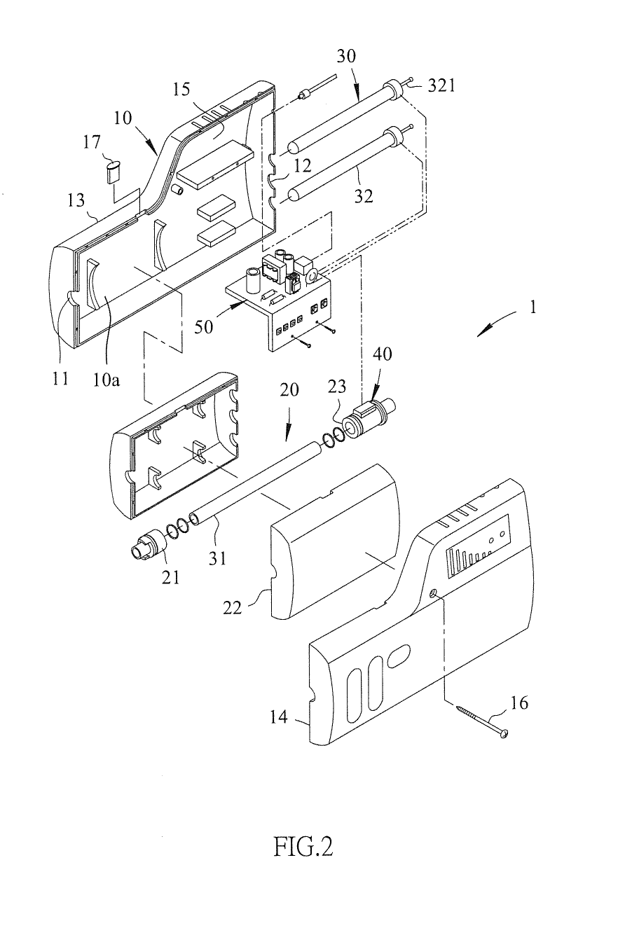

Referring to FIGS. 1 to 3, the ultraviolet-ray lamp water sterilization device 1 of the present invention comprises a body 10 having a first room 10a and a second room 15 defined therein. A first connection hole 11 and a second connection hole 12 are respectively formed in the body 10 and communicate with the first room 10a. A path 19 is formed between the first and second connection holes 11, 12. An exposing portion 20 is located in the first room 10a and between the first and second connection holes 11, 12. A sterilization unit 30 is located in the exposing portion 20. A water flow pressure switch 40 is connected to the second connection hole 12 and communicates with the path 19. A circuit controlling member 50 is located in the second room 15 and has an adaptor so as to obtain the integral and modularized ultraviolet-ray lamp water sterilization device. The circuit controlling member 50 is electrically connected with a power supply, the sterilization unit 30 and the water flow pressure switch 40. The body 10 has a window view 17 which communicates with the interior of the exposing portion 20 so that the user is acknowledged that the exposing portion 20 is in operation.

The path 19 is located in the exposing portion 20 which has a first connector 21, a metallic reaction chamber 22, and a second connector 23. The path 19 is defined in a quartz tube 31. The first and second connectors 21, 23 are respectively connected to two ends of the metallic reaction chamber 22. The quartz tube 31 of the sterilization unit 30 is located in the metallic reaction chamber 22. The quartz tube 31 is a transparent tube and located between two ultraviolet-ray lamps 32. The metallic reaction chamber 22 is made by metal which is easily obtain and manufactured. It is noted that each ultraviolet-ray lamp 32 has a bar 321 connected to one end thereof, and the body 10 has a side cover 18 removably connected thereto which is located corresponding to the bar 321 so that when removing the side cover 18, the ultraviolet-ray lamp 32 can be easily replaced by pulling the bar 321 out from the body 10.

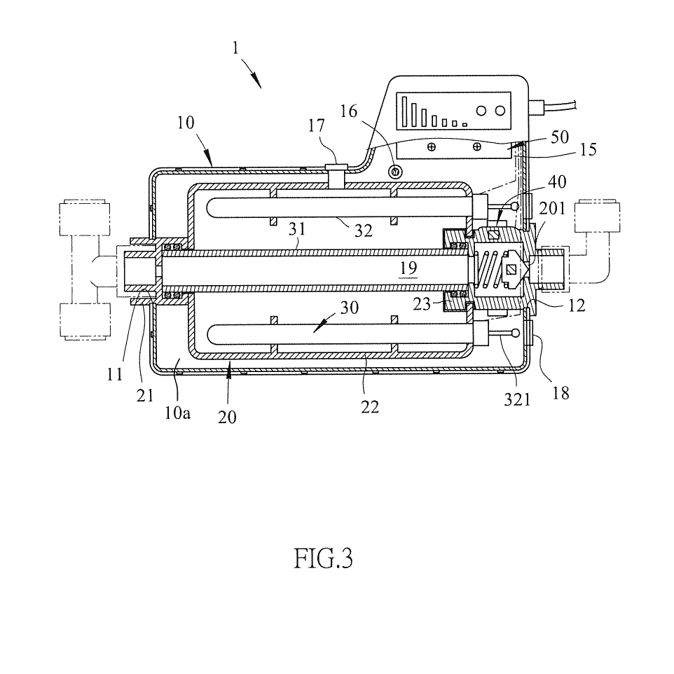

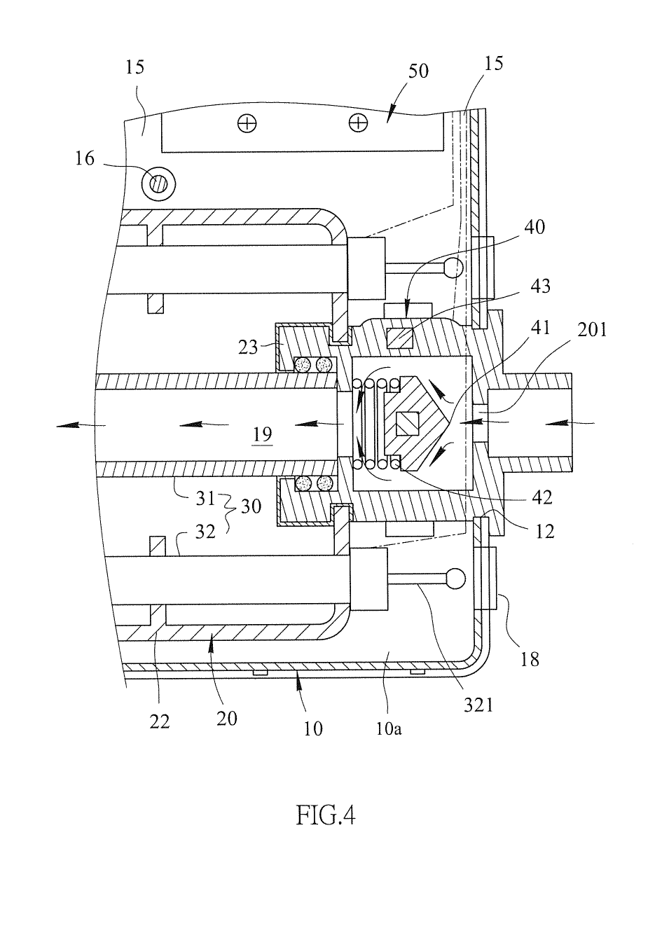

The water flow pressure switch 40 comprises a piston 41, a spring 42 and a magnetic switch 43. The piston 41 is biased by the spring 42 so as to movably seal an inlet 201 (FIG. 3) which communicates with the water flow pressure switch 40 and the path 19. The magnetic switch 43 has two magnets which are respectively located in the piston 41 and in the wall of the water flow pressure switch 40. When water from the water treatment device 6 is introduced in the water flow pressure switch 40, the water pressure pushes the piston 41 to compress the spring 42 toward the path 19, so that the inlet 201 is opened as shown in FIG. 4. The water then enters into the path 19, in the meanwhile, the two magnets of the water flow pressure switch 40 are located at the same vertical plane as shown in FIG. 4, the ultraviolet-ray lamp 32 is activated to sterilize the water. When the water treatment device 6 stops providing water, the spring 42 pushes the piston 41 back to seal the inlet 201. Of course, the water flow pressure switch 40 can be replaced by any similar switch or sensor.

Further referring to FIG. 4, The circuit controlling member 50 stops the operation of the sterilization unit 30 when water in the path 19 maintains stationary for a pre-set period of time for example, two minutes. The circuit controlling member 50 has a warning device installed which includes a Light Emitting Diode (LED) and/or a buzzer so as to respond to pre-set scenarios of the ultraviolet-ray lamp 32 of the sterilization unit 30, such as when the ultraviolet-ray lamp 32 is not operated normally. The circuit controlling member 50 can be controlled by any known methods and chips. It is also noted that the body 10 may have only the first room 10a and does not have the second room 15, the circuit controlling member 50 is attached to the body 10 from outside of the body 10.

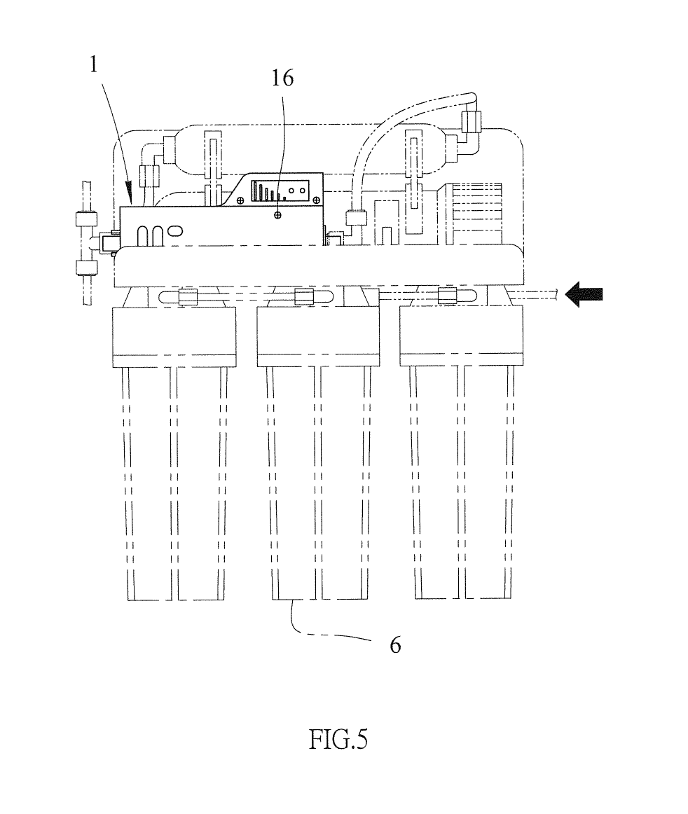

As shown in FIG. 5, the ultraviolet-ray lamp water sterilization device 1 of the present invention is cooperated with the water treatment device 6 to provide clean and reliable water. The metallic reaction chamber 22 blocks the ultraviolet rays from emitting through the metallic reaction chamber 22. The adaptor is integrally connected to the circuit controlling member 50 so that the water treatment device 6 is easily installed and maintained. It is also noted that the circuit controlling member 50 is cooperated with Bluetooth transmitting/receiving device so as to electronically linked with household appliances.

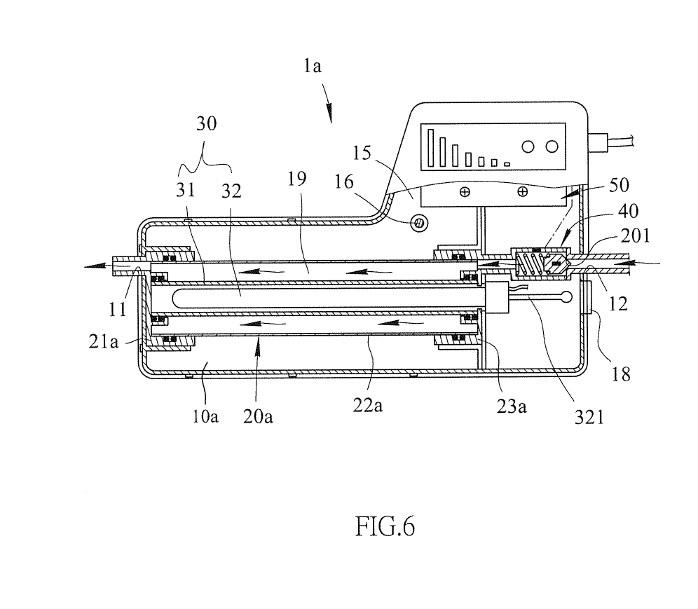

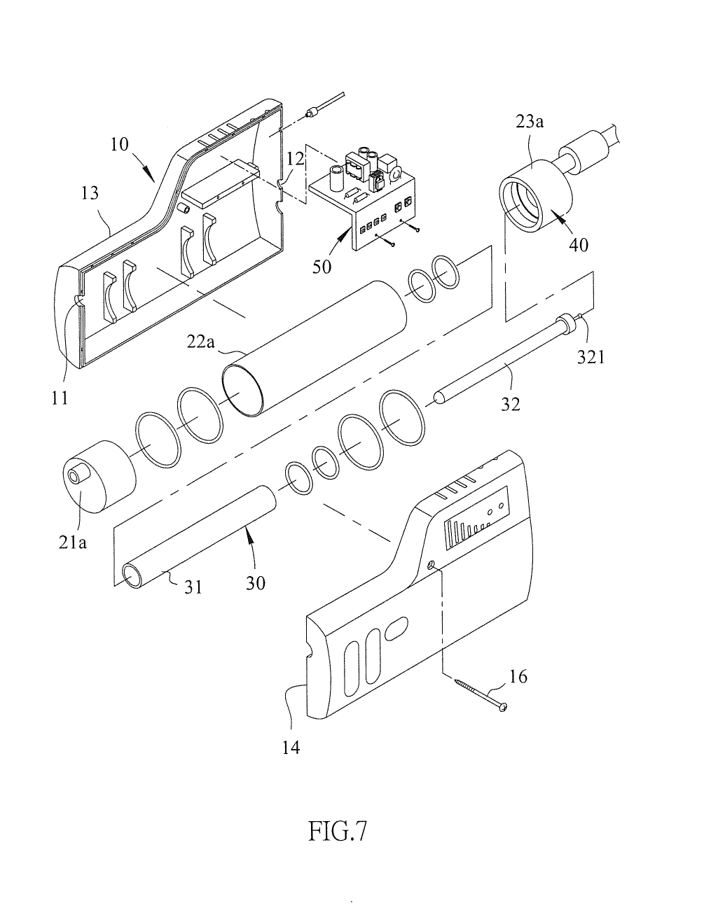

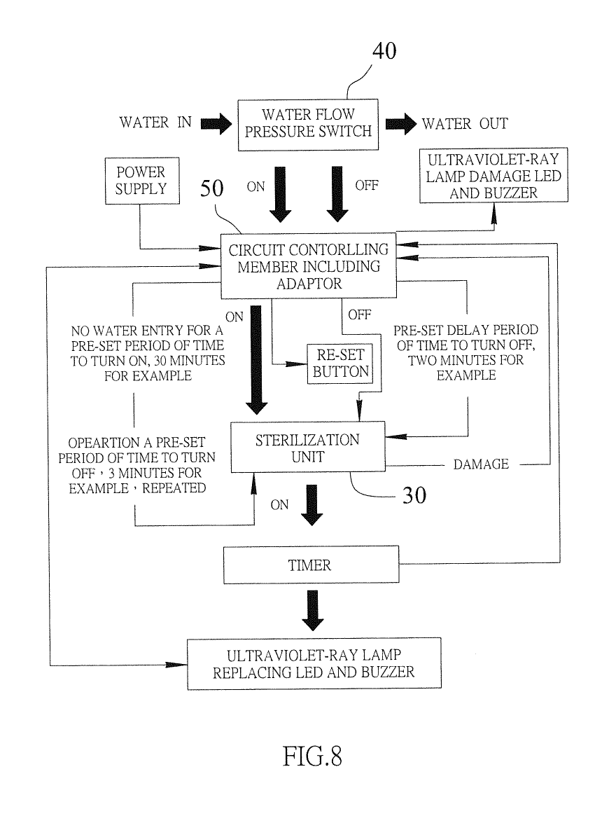

FIGS. 6, 7 and 8 show the second embodiment of the ultraviolet-ray lamp water sterilization device 1a of the present invention comprises a body 10 having a first room 10a and a second room 15 defined therein. A first connection hole 11 and a second connection hole 12 are respectively formed in the body 10 and communicate with the first room 10a. A path 19 is formed between the first and second connection holes 11, 12. An exposing portion 20a is located in the first room 10a and between the first and second connection holes 11, 12. A sterilization unit 30 is located in the exposing portion 20a. A water flow pressure switch 40 is connected to the second connection hole 12 and communicates with the path 19. A circuit controlling member 50 is located in the second room 15 and the adaptor is integrally and modularly installed in the circuit controlling member 50. The circuit controlling member 50 is electrically connected with the sterilization unit 30 and the water flow pressure switch 40.

The path 19 is located in the exposing portion 20a which has a first connector 21a, a metallic reaction chamber 22a, and a second connector 23a. The first and second connectors 21a, 23a are respectively connected to two corners of the metallic reaction chamber 22a. The quartz sleeve tube 31 of the sterilization unit 30 is located in the metallic reaction chamber 22a. The quartz sleeve tube 31 is a transparent tube and an ultraviolet-ray lamp 32 is located in the quartz sleeve tube 31. The path 19 is defined in the metallic reaction chamber 22a in which the quartz sleeve tube 31 and the ultraviolet-ray lamp 32 are located. The ultraviolet-ray lamp 32 has a bar 321 connected to one end thereof, and the body 10 has a side cover 18 removably connected thereto which is located corresponding to the bar 321 so that when removing the side cover 18, the ultraviolet-ray lamp 32 can be easily replaced by pulling the bar 321 out from the body 10.

The operation of the water flow pressure switch 40 and the circuit controlling member 50 are the same as previously described.

For both of the first and second embodiments, the circuit controlling member 50 has a timer which counts operation time of the ultraviolet-ray lamp(s) 32 of the sterilization unit 30, in a way to provide lamp service life information to the users. Therefore, the users can replace new ultraviolet-ray lamp(s) 32 when the operation hours reached the pre-set value.

The circuit controlling member 50 makes the ultraviolet-ray lamp(s) 32 keep on operating for a pre-set period of time for example, two minutes after the water treatment device 6 stops providing water.

When the water remains still (or no water is introduced) for a pre-set period of time, for example 30 minutes, the ultraviolet-ray lamp(s) 32 are re-activated for a pre-set period of time, for example 3 minutes to ensure that the germs in the water cannot be reproduced. This action is repeatedly operated.

The circuit controlling member 50 may have a re-set button to initialize the status of the timer and the buzzer. The circuit controlling member 50 may also have a power indication LED display, an ultraviolet-ray lamp replacing indication LED display, an ultraviolet-ray lamp damage indication LED display and other needed indication LEDs displays.

The present invention further comprises a method for controlling an ultraviolet-ray lamp water sterilization device 1, la, comprising:

a step of installing an exposing portion 20, 20a: installing an exposing portion 20, 20a in a body 10 and the exposing portion located between a first connection hole 11 and a second connection hole 12 of the body 10, a path 19 being formed between the first and second connection holes 11, 12;

a step of installing a sterilization unit 30: installing a sterilization unit 30 in the exposing portion 20, 20a;

a step of installing a water flow pressure switch 40: installing a water flow pressure switch 40 to the second connection hole 12 of the body 10;

a step of installing a circuit controlling member 50: installing a circuit controlling member 50 in the body 10, the circuit controlling member 50 having an adaptor and electrically connected with the sterilization unit 30 and the water flow pressure switch 40, the circuit controlling member 50 stopping operation of the sterilization unit 30 when water maintains stationary for a pre-set of time, and

a step of timing the sterilization unit 30: the circuit controlling member 50 having a timer which aggregates operation time of an ultraviolet-ray lamp 32 of the sterilization unit 30.

In the step of installing a circuit controlling member 50, the sterilization unit 30 is activated for a pre-set period of time and then stops when the water remains still for a pre-set period of time.

In the step of installing a circuit controlling member 50, a warning device is installed which includes a Light Emitting Diode and/or a buzzer so as to respond to pre-set scenarios of the ultraviolet-ray lamp 32 of the sterilization unit 30.

While we have shown and described the embodiment in accordance with the present invention, it should be clear to those skilled in the art that further embodiments may be made without departing from the scope of the present invention.

What is claimed is:

1. An ultraviolet-ray lamp water sterilization device comprising:
a body having a first room defined therein, a first connection hole and a second connection hole respectively formed in the body and communicating with the first room, a path formed between the first and second connection holes;
an exposing portion located in the first room and between the first and second connection holes;
a sterilization unit located in the exposing portion;
a water flow pressure switch connected to the second connection hole and communicating with the path, and
a circuit controlling member connected to the body and having a driving adaptor and being electrically connected with the sterilization unit and the water flow pressure switch, the circuit controlling member stopping operation of the sterilization unit when water maintains stationary for a pre-set period of time.

2. The device as claimed in claim 1, wherein the water flow pressure switch comprises a piston, a spring and a magnetic switch, the piston is biased by the spring so as to movably seal an inlet which communicates with the path, the magnetic switch has two magnets which are respectively located in the piston and in a wall of the water flow pressure switch.

3. The device as claimed in claim 1, wherein the body has a second room defined therein and the circuit controlling member is located in the second room.

4. An ultraviolet-ray lamp water sterilization device comprising:
a body comprising a first half and a second half which is connected to the first half by a connection member, the body having a first room defined therein, a first connection hole and a second connection hole respectively formed in the body and communicating with the first room, a path formed between the first and second connection holes;
an exposing portion located in the first room and between the first and second connection holes, the exposing portion having a metallic reaction chamber therein;
a sterilization unit located in the exposing portion;
a water flow pressure switch connected to the second connection hole and communicating with the path, and
a circuit controlling member connected to the body and having a driving adaptor and being electrically connected with the sterilization unit and the water flow pressure switch.

5. The device as claimed in claim 4, wherein the exposing portion has a first connector, a metallic reaction chamber, and a second connector, the first and second connectors are respectively connected to two ends of the metallic reaction chamber, the sterilization unit is located in the metallic reaction chamber.

6. The device as claimed in claim 4, wherein the sterilization unit has a first connector, a metallic reaction chamber, and a second connector, the first and second connectors are respectively connected to two corners of the metallic reaction chamber, the sterilization unit is located in the metallic reaction chamber.

7. The device as claimed in claim 6, wherein the body has a window view which communicates with an interior of the metallic reaction chamber.

8. The device as claimed in claim 4, wherein the sterilization unit has an ultraviolet-ray lamp which has a bar connected to one end thereof, the body has a side cover removably connected thereto which is located corresponding to the bar.

9. The device as claimed in claim 4 further comprising a wireless communication module which transmits signal therefrom and receives signals from outside.

10. The device as claimed in claim 4, wherein the body has a second room defined therein and the circuit controlling member located in the second room.

11. A method for controlling an ultraviolet-ray lamp water sterilization device, comprising:
a step of installing an exposing portion: installing an exposing portion in a body and the exposing portion located between a first connection hole and a second connection hole of the body, a path being formed between the first and second connection holes;
a step of installing a sterilization unit: installing a sterilization unit in the exposing portion;
a step of installing a water flow pressure switch: installing a water flow pressure switch to the second connection hole of the body;
a step of installing a circuit controlling member: installing a circuit controlling member in the body, the circuit controlling member having an adaptor and electrically connected with the sterilization unit and the water flow pressure switch, the circuit controlling member stopping operation of the sterilization unit when water maintains stationary for a pre-set of time, and
a step of timing the sterilization unit: the circuit controlling member having a timer which aggregates operation time of an ultraviolet-ray lamp of the sterilization unit.

12. The method as claimed in claim 11, wherein in the step of installing a circuit controlling member, the sterilization unit is activated for a pre-set period of time and then stops when the water remains still for a pre-set period of time.

13. The method as claimed in claim 11, wherein in the step of installing a circuit controlling member, a warning device is installed which includes a Light Emitting Diode and/or a buzzer so as to respond to pre-set scenarios of the ultraviolet-ray lamp of the sterilization unit.
